(19) United States
(12) Patent Application Publication
(10) Pub. No.: US 2013/0089125 A1
(43) Pub. Date: Apr. 11, 2013

(54) CABLE MODEM DEVICE OF COAXIAL CABLE NETWORK USING USB INTERFACE, METHOD USING IT AND COAXIAL CABLE NETWORK SYSTEM

(71) Applicant: LG INNOTEK CO., LTD., Seoul (KR)

(72) Inventor: Nam Kim, Seoul (KR)

(73) Assignee: LG INNOTEK CO., LTD., Seoul (KR)

(21) Appl. No.: 13/648,545

(22) Filed: Oct. 10, 2012

(30) Foreign Application Priority Data
Oct. 10, 2011 (KR) 10-2011-0103189

(51) Int. Cl. H04B 1/38

(52) U.S. Cl. 375/222

(57) ABSTRACT

A cable modem device using a USB (universal serial bus) interface according to the embodiment includes a modem for converting network data received from a coaxial cable network through a coaxial cable, a USB interface converter for converting a format of the network data into a USB interface format to output the network data to an external device through the USB interface, and a power supply for supplying a power. The power supply receives the power from the external device through the USB interface and provides the power to the modem and the USB interface converter.

### BACKGROUND

The embodiment relates to a cable modem of a coaxial cable network using a USB (Universal Serial Bus) interface, a connecting method of the same and a coaxial cable network system, and more particularly, to a cable modem which converts network data input through a cable to transmit the converted data to an external device.

In general, Internet network service is implemented through a dedicated line network using a cable modem and gigabit optical Ethernet

FIG. 1 is a view illustrating a connecting state of a general cable modem.

Referring to FIG. 1, the general cable modem 15 is an access device enabling a high-rate data access to Internet by using a coaxial cable network 10. The cable modem 15 transmits the network data received through a coaxial cable 11 to an external device 13 using an Ethernet interface 12. Further, the cable modem 15 transmits the data, which are received through the Ethernet interface 12 from the external device 13, to the coaxial cable network 10 through the coaxial cable 11.

However, since the general cable modem 15 requires an Ethernet connection with the external device 13, the connection between the external device 13 and the cable modem 15 is complex.

Further, since the general cable modem 15 requires a power supply 14 and an adaptor 16, the wiring and the configuration of the general cable modem 15 become complex.

Since the general cable modem 15 is usable when a module which can transmit and receive data to and from the external device 13 through the Ethernet interface is mounted on the general cable modem 15, the network connection of the general cable modem 15 to an external device having no Ethernet interface module is impossible.

### SUMMARY

The embodiment provides a cable modem device capable of simplifying a connection between a cable modem and an external device.

The embodiment provides a cable modem device which has no power supply and operates by receiving power from an external device, so that the installation work can be facilitated and the wiring and the configuration of the cable modem device can be simplified.

The embodiment provides a cable modem device which can be connected with an external device through a network without any Ethernet interface module.

A cable modem device according to the embodiment includes a modem for converting network data received from a coaxial cable network through a coaxial cable; a USB (universal serial bus) interface converter for converting a format of the network data into a USB interface format to output the network data to an external device through the USB interface; and a power supply for supplying a power, wherein the power supply receives the power from the external device through the USB interface and provides the power to the modem and the USB interface converter.

A network connecting method of a cable modem device according to the embodiment includes the steps of: connecting an external device with the cable modem device through a USB (universal serial bus) interface; receiving a power from the external device through the USB interface to provide the power to a modem and a USB interface converter; demodulating network data received from a coaxial cable network through a coaxial cable by the modem to output the network data in a MII (media independent interface) format; and converting the MII format of the output network data into a USB interface format by the USB interface converter to output the network data of the USB interface format to the external device through the USB interface.

A coaxial cable network system according to the embodiment includes a server for transmitting network data through a coaxial cable network; a cable modem device for receiving the network data from the server, demodulating the network data to generate data of a MII (media independent interface) format, and converting the MII format of the data into a USB (universal serial bus) interface format to output the data through a USB interface; and an external device for receiving the network data output through the USB interface and providing a power to the cable modem device through the USB interface.

According to the embodiment, the connection between devices may be simplified by substituting the USB interface for an Ethernet cable (LAN line) in a general cable modem.

Meanwhile, since a dedicated power supply is not needed and the power is received from an external device through the USB interface, the installation work can be simplified.

Since an Ethernet interface is not required in the external device, the cable modem device can be connected with an external device through a network even if the external device has only a USB interface without any Ethernet interface.

### BRIEF DESCRIPTION OF THE DRAWINGS

FIG. 1 is a schematic view illustrating one example of a general cable modem;

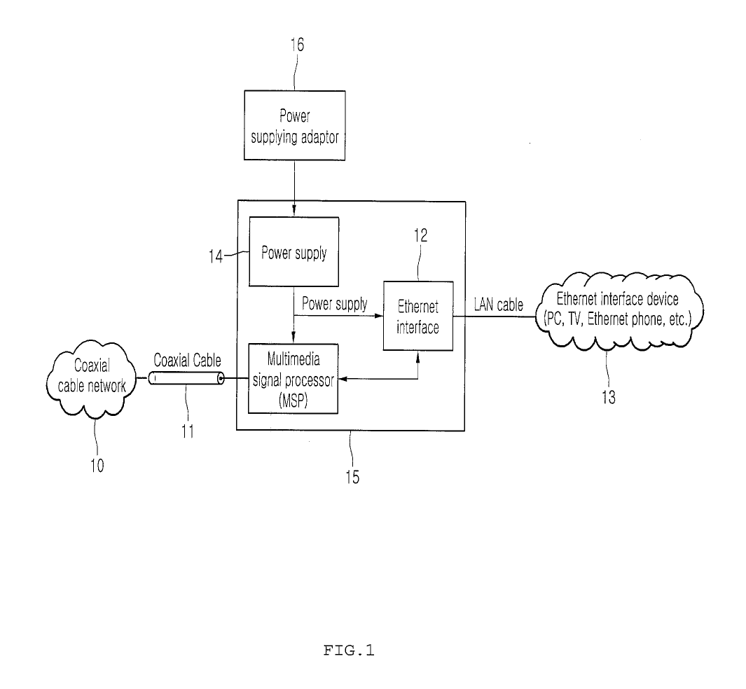

FIG. 2 is a schematic view showing a configuration of a cable modem device according to the embodiment;

FIG. 3 is a view showing the detailed configuration of the cable modem device depicted in FIG. 2;

FIG. 4 is a schematic view showing one example of a coaxial cable network system according to the embodiment; and

FIG. 5 is a flowchart illustrating a network connecting method of a cable modem device according to the embodiment.

### DETAILED DESCRIPTION OF THE EMBODIMENTS

Hereinafter, the embodiment will be described in more detail with reference to accompanying drawings.

In the following description, the suffix “˜unit” and “˜part” may be used to facilitate the description of the specification and may be compatibly used with each other.

Furthermore, although the embodiment will be described in detail below with reference to accompanying drawings and contents denoted in the drawings, the embodiment is not limited thereto.

Terminologies used in this specification are selected from general terminologies by taking the functions thereof into consideration and they may vary depending on the intentions of operators having ordinary skill in the art, customers and appearance of new technologies. In specific cases, the terminologies may be arbitrarily selected by applicant. In this case, the meaning of the terminologies will be described in corresponding parts of the specification. Accordingly, the terminologies used in this specification should be defined based on the substantial meanings thereof and the whole context throughout the present specification.

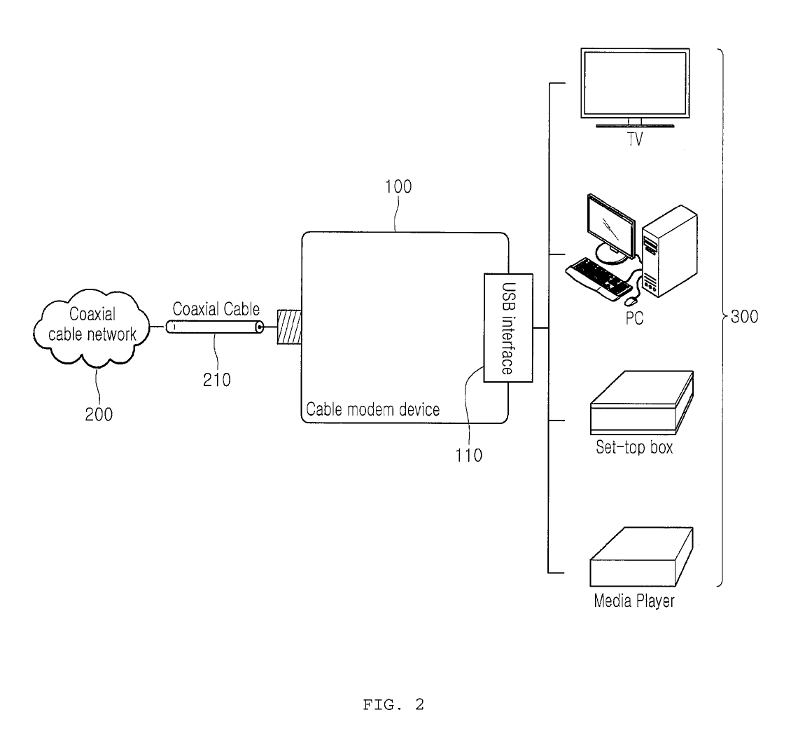

FIG. 2 is a schematic view showing a configuration of a cable modem device 100 according to the embodiment.

As shown in FIG. 2, the cable modem device according to the embodiment performs the functions of receiving network data from a coaxial cable network 200 through a coaxial cable 210 and transmitting the received data to an external device 300 through a USB interface 110.

Since the cable modem device 100 receives power from the external device 300, the cable modem device 300 does not need any individual power supply or adaptor.

Meanwhile, the external device 300 may receive network data through the USB interface 110. Thus, the external device 300 does not need to have any Ethernet interface. This is because the external device 300 may connect with a network through the USB interface 110.

A plurality of external devices 300 may be provided and the external device 300 may include one of a computer including a USB interface module, a portable terminal, a multimedia playback apparatus and a television.

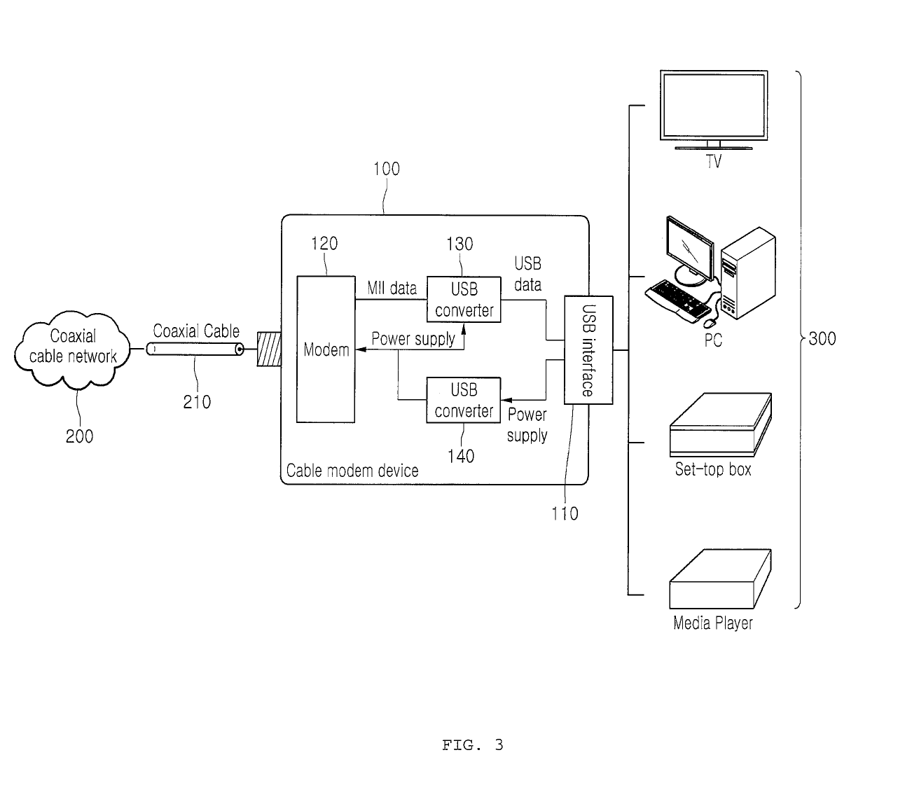

FIG. 3 is a view showing the detailed configuration of the cable modem device 100 according to the embodiment.

The configuration of the cable modem 100 according to the embodiment will be described in detail with reference to FIG. 3. As shown in FIG. 3, the cable modem device 100 of the embodiment may include a modem 120, a USB (Universal Serial Bus) interface converter 130 (hereinafter, referred to as a converter), and a power supply 140.

The modem 120 demodulates network data received from a coaxial cable network 200 through a coaxial cable 210 and outputs data of the MII (Media Independent Interface) format.

In detail, the modem 120 separates a network signal from the data received through the coaxial cable 210 and demodulates the network signal. The modem 120 may include a duplexer (not shown) for receiving a signal through the coaxial cable 210 and separating the a network signal from the received signal, a network processor (not shown) for processing data, an RF transceiver (not shown) for access to a broadband communication network , and an Ethernet module (not shown).

The modem 120 may convert the network data into the data of the MII format through the network processor. The Media Independent Interface (MII) means an interface between a MAC (Media Access Control) layer and a PHY (Physical) layer in a LAN (Local Area Network) of CSMA/CD (Carrier Sense Multiple Access with Collision Detection) of 10 Mbps or 100 Mbps. Therefore, the MII may include a MAC layer interface and a PHY interface.

In detail, the MII is defined in IEEE 802.3U and is employed in the previous 802.3 standard. The MII provides an interface between a MAC layer controller on an NIC (LAN card) and a PHY layer interface and is defined for changing only the PHY layer interface without changing the MAC layer. For example, when an interface of a device is changed, there is no need to change an entire NIC if a module consisting of the NIC is changed.

In addition, in the MAC layer interface and the PHY layer interface, TX data (4-bit), a TX clock, a TX Enable, RX data (4-bit), an RX clock, an RX Valid, and CRS (circuit reset) are matched with each other.

The TX data and the RX data are configured as a 4-bit data bus for transmitting and receiving data between the MAC layer interface and the PHY layer interface, and the buses are synchronized by specific clocks.

That is, the TX clock is used as a reference clock of the TX bus, and the RX clock is used as a reference clock of the RX bus. The TX enable is a signal for informing a counterpart (receiving part) of the fact that transmitted data are prepared, and connects with the RX Valid of the receiving part.

A reference clock is necessary to normally operate the signals. A clock generator (not shown) generally provides a reference clock of 25 Mhz. Thus, the modem 120 transmits and receives data using a clock input thereto as the reference clock.

Meanwhile, the USB converter 130 performs the functions of converting the MII format of the output data into the USB format and outputting the converted data to the external device 300 through the USB interface 110.

The converter 130 may include a microprocessor (not shown) equipped with a USB serial communication controller for supporting a USB conversion. Further, the converter 130 may include a USB transceiver (not shown) and a memory block (not shown). The memory block may include memories such as a flash memory or a DRAM memory and may be used as a temporal storage unit used for downloading a program or converting data.

Since the method for converting the MII format into the USB format using the microprocessor and the memory block which is used in the converter 130 is performed through a USB-to-MII controller chipset generally known in the art, the detailed description thereof will be omitted.

Meanwhile, the network data of the USB format which result from the conversion of the converter 130 are transmitted to the external device 300 through the USB interface 110. Thus, the external device 300 may be connected to the coaxial cable network 200 through the USB interface 110 without any Ethernet interface, so that an Internet service may be available.

In addition, the cable modem device 100 according to the embodiment includes the power supply 140 for supplying the modem 120 and the converter 130 with electrical power. The power supply 140 receives the power from the external device 300 through the USB interface 110 and supplies the modem 120 and the converter 130 with the operating power.

Thus, the power supply 140 may include a power supply circuit (not shown) for supplying the power received according to the USB standard to the modem 120 and the converter 130. The power supply circuit may include terminals connected to the USB interface 110 for receiving power and a ground terminal for grounding. Since the technology for receiving power through the USB interface 110 is generally known in the art, the detailed description thereof will be omitted.

As described above, the power supply 140 receives the power transmitted from the external device 300 through the USB interface 110 and uses the received power for operating the modem 120 and the converter 130, so that the device is operable without any adaptor and the installation and wiring work is simplified.

In sum, the modem 120 receives the network data through the coaxial cable and converts the format of the data into the MII format. The USB converter 130 converts the MII format of the data into the USB format and transmits the data of the USB format to the external device 300 through the USB interface 110. The power supply 140 uses power provided from the external device 300 through the USB interface 110 to provide power to the modem 120 and the USB converter 130.

The cable modem device 100 according to the embodiment may perform a data conversion and communication in the direction that is opposite to the above-described direction.

In more detail, the external device 300 may transmit data to the coaxial cable network 200 in order to use an Internet service. The converter 130 may convert the USB format of the network data received from the external device 300 into the MII format. The modem 120 may modulate the network data of the MII format and transmit the modulated data through the coaxial cable. The procedure of transmitting data to the network by the external device may be performed reversely to the receiving procedure.

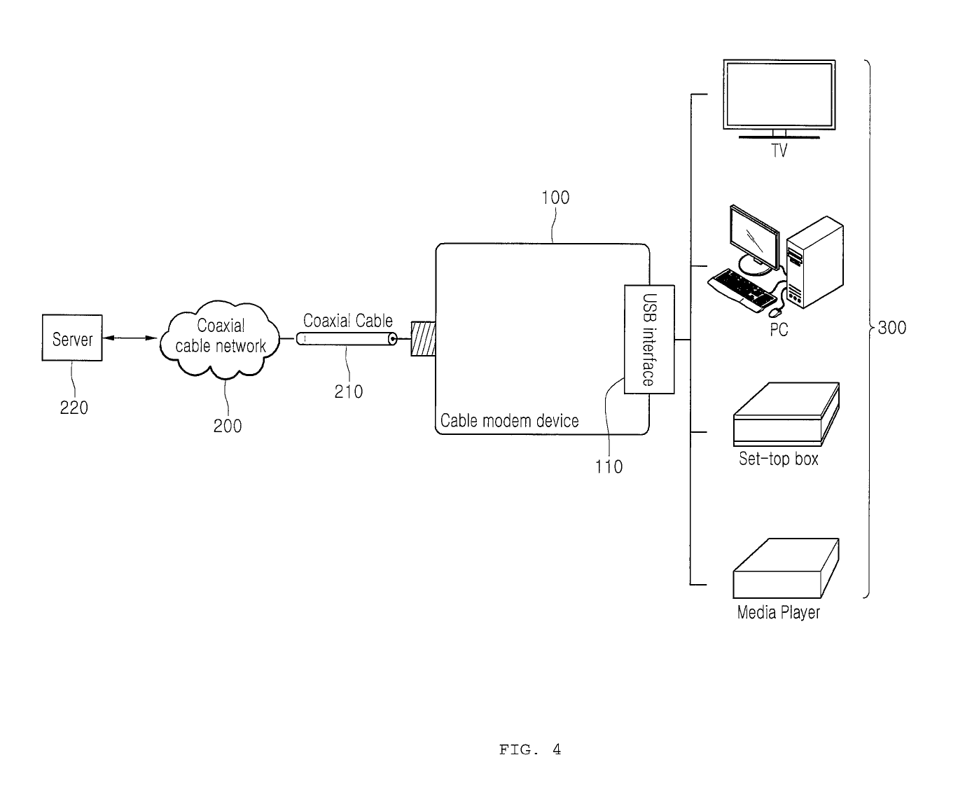

FIG. 4 is a conceptive view illustrating one example of a coaxial cable network system according to the embodiment.

As shown in FIG. 4, the coaxial cable network system according to the embodiment includes a server 220 for transmitting network data through a coaxial cable network 200, a cable modem device 100 for receiving the network data from the server 220, demodulating the network data to generate data of the MII format, converting the MII format of the data into the USB format, and outputting the data through a USB interface 110, and an external device 300 for receiving the network data output from the USB interface 110 and providing power to the cable modem device 100 through the USB interface 110.

The sever 220 may a service provision device for providing an Internet service or a broadcasting service by transmitting and receiving the network data through the coaxial cable network 200, and may include a controller and a memory for processing data.

The server 220 may provide various kinds of network services by a service provider. Examples of the provided service may include an Internet service, terrestrial broadcasting, cable broadcasting, and satellite broadcasting. Various applications as well as broadcasting contents may be packaged and provided to a user. Thus, the cable modem device 100 for receiving the provided services may further include a tuner, demodulator and a network interface for receiving broadcasting.

The network data that are transmitted or received to or from the external device may include contents such as movies, an advertisement, a game, a VOD, or a broadcasting program and information about the contents. Further, the network data may include information about a firmware update provided by a network operator and an update file. The external device 300 may transmit data to the server 220, such that the external device 300 may transmit data to an Internet or content provider or a network operator.

Meanwhile, since the configuration and the operation of the cable modem device 100 and the external device 300 have been described above, the detailed description about the configuration and the operation of the cable modem device 100 and the external device 300 will be omitted.

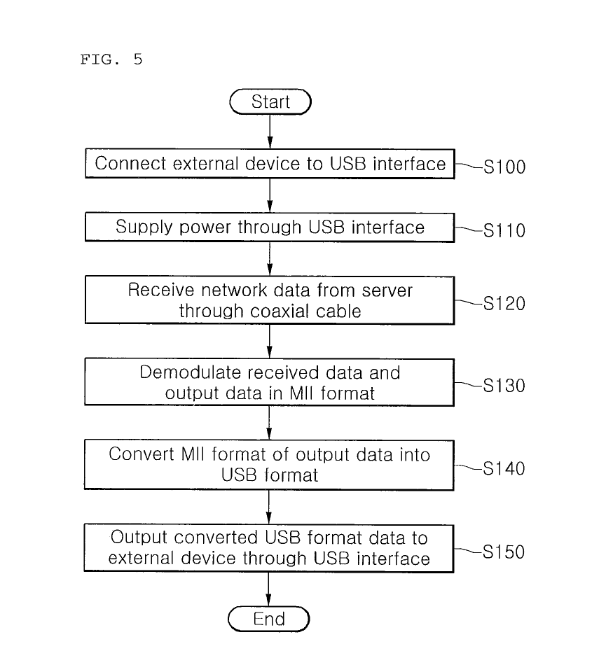

FIG. 5 is a flowchart illustrating a network connecting method of a cable modem device 100 according to the embodiment.

Hereinafter, the network connecting method according to the embodiment will be described with reference to FIG. 5. First, in step S100, a user connects a desired external device 300 and a cable modem device 100 to Internet or the coaxial cable network 200 by using the USB interface 110. The external device 300 refers to a device which does not require an Ethernet interface, but can be connected to the network through the USB interface.

In step S110, the power supply 140 receives the power from the external device 300 through the USB interface 110 connected to the power supply 140. The supplied power is input to the modem 120 and the converter 130 in the cable modem device 100 as an operating power.

In step S120, if the power is supplied, the modem 120 receives the network data through the coaxial cable 210 from the server 220. In order to receive the network data, a step of separating the network data from the signal received through the coaxial cable 210 may be further provided.

In step S130, the received data are demodulated and the format of the received data is converted into the MII format by the modem 120. Then, the converted data are output to the converter 130.

In step S140, the converter 130 converts the MII format of the data into the USB format. In step S150, the converted network data are output through the USB interface 110 to the external device 300 connected thereto.

The output network data of the USB format may be received in the external device 300 so that the external device 300 may use a network service such as an Internet service.

As described above, the network connecting method of the cable modem device according to the embodiment may be prepared as a computer-executable program and may be recorded on a computer-readable recording medium. For example, the computer-readable recording medium includes a ROM, a RAM, a CD-ROM, a magnetic tape, a floppy disk, and an optical data storage device. Further, the computer-readable recording medium may be implemented in the form of a carrier wave (for example, transmission through Internet).

The computer-readable recording medium may be distributed in computer systems connected with each other through a network and a code which is readable by a computer in a distribution scheme may be stored and executed in the computer-readable recording medium. A functional program, a code and code segments for implementing the method may be easily deduced by programmers skilled in the related art.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A cable modem device using a USB (universal serial bus) interface, the cable modem device comprising:
a modem for converting network data received from a coaxial cable network through a coaxial cable;
a USB interface converter for converting a format of the network data into a USB interface format to output the network data to an external device through the USB interface; and
a power supply for supplying a power,
wherein the power supply receives the power from the external device through the USB interface and provides the power to the modem and the USB interface converter.

2. The cable modem device of claim 1, wherein the USB interface converter converts the USB interface format of the network data received from the external device into a MII (media independent interface) format.

3. The cable modem device of claim 2, wherein the modem modulates the network data of the MII format to transmit the network data of the MII format to an optical coaxial network through a cable.

4. The cable modem device of claim 1, wherein the external device includes a device connectable with a network through the USB interface.

5. The cable modem device of claim 3, wherein the external device includes a plurality of devices and the devices include at least one of a TV, a PC, a media player, and a set-top box.

6. The cable modem device of claim 1, wherein the modem demodulates the network data to output the network data in a MII (media independent interface) format.

7. The cable modem device of claim 4, wherein the power supply includes:
a terminal connected to the USB interface to receive the power; and
a ground terminal for grounding.

8. A network connecting method of a cable modem device, the network connecting method comprising:
connecting an external device with the cable modem device through a USB (universal serial bus) interface;
receiving a power from the external device through the USB interface to provide the power to a modem and a USB interface converter;
demodulating network data received from a coaxial cable network through a coaxial cable by the modem to output the network data in a MII (media independent interface) format; and
converting the MII format of the output network data into a USB interface format by the USB interface converter to output the network data of the USB interface format to the external device through the USB interface.

9. The network connecting method of claim 8, further comprising:
converting the USB interface format of the network data received from the external device into the MII format; and
modulating the network data of the MII format to transmit the network data to the coaxial cable network through the coaxial cable.

10. The network connecting method of claim 8, wherein the external device includes a device connectable with a network through the USB interface.

11. The network connecting method of claim 10, wherein the external device includes a plurality of devices and the devices include at least one of a TV, a PC, a media player, and a set-top box.

12. A coaxial cable network system comprising:
a server for transmitting network data through a coaxial cable network;
a cable modem device for receiving the network data from the server, demodulating the network data to generate data of a MII (media independent interface) format, and converting the MII format of the data into a USB (universal serial bus) interface format to output the data through a USB interface; and
an external device for receiving the network data output through the USB interface and providing a power to the cable modem device through the USB interface.

13. The coaxial cable network system of claim 12, wherein the external device transmits the data to the cable modem device through the USB interface, and the cable modem device converts a format of the transmitted data into the MII format and modulates the data of the MII format to transmit the data to the server through coaxial cable network.

14. The coaxial cable network system of claim 12, wherein the external device includes a device connectable with a network through the USB interface.

15. The coaxial cable network system of claim 14, wherein the external device includes a plurality of devices and the devices include at least one of a TV, a PC, a media player, and a set-top box.
